(19) United States
(12) Patent Application Publication
(10) Pub. No.: US 2003/0018974 A1
(43) Pub. Date: Jan. 23, 2003

(54) Image delivery system, image delivery method, and recording medium in which image delivery program is recorded

(75) Inventor: Takaaki Suga, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 10/026,461

(22) Filed: Dec. 27, 2001

(30) Foreign Application Priority Data
Jul. 18, 2001 (JP) 2001-218072

(51) Int. Cl. H04N 7/173; G06F 15/16

(52) U.S. Cl. 725/86; 709/219; 725/91

(57) ABSTRACT

To provide an image delivery system which allows users to previously check their video images that have been obtained at leisure facilities, such as theme parks and aquariums, and megastores, and which also allows the users to edit the images so as to comply with their preferences. The system, being interconnected with a user terminal via an communications network, includes: means for storing a master file that records video images of plural users substantially continuously; means for storing link information linking a plurality of parts of the master file with the respective users; and means, responsive to the receipt of an file delivery request of a user from a user terminal, for reading out a corresponding one of the plural parts of the master file, in which part the user appears, and delivering the read-out part to the terminal through the communications network.

### BACKGROUND OF THE INVENTION

1. Field of the Invention

The present invention relates to an image delivery system and method, and a computer-readable recording medium, which are suitable for use in delivering moving-visual-images (hereinafter also called video images) obtained at leisure facilities, such as theme parks and aquariums, and recently emerging megastores, through a communications network (for example, the Internet).

2. Description of the Related Art

In Japan, there have recently been installed, in urban areas and various leisure facilities, image processing systems which take photo images of users to generate composite photo images of the users and pre-installed static images in a device constituting the system, and which then output the composite photos on the spot.

It is expected that as an extension of such an image processing system, another type of system may find a market in the near future. Such a new system takes video images of users (customers) at leisure facilities, such as theme parks and aquariums, and recent megastores, and then combines the users' images with images (unique to the system-installed places) pre-installed in a device constituting the system, so as to generate composite video images. The system also allows editing of two or more video images obtained at several positions in the facilities or the stores to output the video images in an edited fashion.

The former system, which outputs composite user images and any pre-installed images, could complete image processing fairly quickly. Thus, in spite of the fact that users must wait for the generated composite picture image to be output on the spot for a while, user friendliness is not impaired significantly because such waiting time is rather short.

In comparison with this, assuming the composite of video images and preinstalled images is provided, it would take a significantly long time to go through the image processing. In addition, in order to realize the on-the-spot trading of video images, composite video images and edited video images must be copied to videotapes (analog medium), which are then sold to users, thereby necessitating an increased time period (video replay period) in carrying out such copying. Taking into consideration these points, in order to realize the on-the-spot video image-providing service, in which video images that have been shot and undergone some image processing are provided, it would be most important to reduce the time period necessary for preparing the resulting output to be provided to users.

To resolve this problem, that is, to reduce the processing time, an idea of adding some limitations has been thought of, such as greatly shortening the length of a video image. In that case, however, it would be impossible to fulfill users' requirements for obtaining videoed images that have undergone some image processing.

Accordingly, the present applicant has already proposed an image processing system (Japanese Unexamined Patent Application Publication No. HEI 10-215434), which automatically starts editing plural video images of a user immediately after the images are obtained, and then automatically copies the edited images to a videotape (analog medium), so that the processing time is reduced as much as possible to reduce the waiting time of the user.

Here, it is considered that the contents and the quality of the video images to be provided after undergoing image processing are significantly important to users when deciding whether to purchase the video images. Considering this, even if videoed images were arranged in sequence mechanically, it would not be so attractive to users that they purchase the images, and hence, it would not be easy to establish such a video image-providing service as a new business.

In order to meet users' needs and to succeed in making the new business flourish, it seems essential that users are allowed to check the contents of video images before purchasing them and also to edit the video images in accordance with their liking, so that the users can be provided with video images whose contents and quality are satisfactory to them.

In the above-mentioned prior art, however, since video images are automatically copied to videotapes after completion of editing processing so as to reduce the processing time as much as possible, it is impossible for users to check the video images before purchasing them or to edit the images so as to obtain the resulting output in compliance with their preferences.

### SUMMARY OF THE INVENTION

With the foregoing problems in view, one object of the present invention is to provide an image delivery system which allows users to previously check their video images that have been obtained at leisure facilities, such as theme parks and aquariums, and recently emerging megastores, and which also allows the users to edit the images to meet with their preferences.

Another object of the invention is to provide an image delivery method which is to be carried out in the above-mentioned system.

A further object of the invention is to provide a computer-readable recording medium in which an image delivery program is stored.

In order to accomplish the above object, according to the present invention, there is provided an image delivery system for delivering an object moving-visual-image file (hereinafter called the object file) to a terminal communicably connected to the system through a communications network, the system comprising: (a) image storage means for storing a master moving-visual-image file (hereinafter called the master file), containing individual moving visual images of a plurality of users and previously obtained by videoing the plural users substantially continuously; (b) link information management means for storing link information linking a plurality of parts of the master file, which is stored in the image storage means, with the respective users; and (c) image delivery control means, responsive to the receipt of an object-file delivery request of one individual user from the terminal, for reading out a corresponding one of the plural parts of the master file, in which part the individual user appears, from the storage means, and delivering the read-out part of the master file to the terminal through the communications network as the object file.

As one preferred feature, the image delivery system further comprises (d) image editing control means, responsive to the receipt of an object-file editing and delivery request of one individual user from the terminal, for reading out a corresponding one of the plural parts of the master file, in which part the individual user appears, based on the link information, from the storage means, editing the read-out part of the master file, and delivering the resulting part of the master file to the terminal as the edited object file.

As another preferred feature, the image delivery system further comprises (e) erasing control means for erasing the corresponding one of the plural parts of the master file stored in the image storage means, in which part the individual user appears, after the edited object file has been delivered to the terminal.

As still another preferred feature, the image delivery control means controls an image delivering rate in terms of the number of image frames per second in accordance with a condition of connection of the terminal with the communications network.

As one generic feature, there is provided an image delivery method for delivering an object moving-visual-image file (hereinafter called the object file) from a delivery source to a terminal communicably connected to the delivery source through a communications network, which method comprises the steps of: (a) storing both a master moving-visual-image file (herein after called the master file), which contains individual moving visual images of a plurality of users and was previously obtained by videoing the plural users substantially continuously, and link information linking a plurality of parts of the master file with the respective users, into a storage device, which is a component of the delivery source or an external element communicably connected with the delivery source; and at the delivery source, (b) upon receipt of an object-file delivery request of one individual user from the terminal, reading out a corresponding one of the plural parts of the master file, in which part the individual user appears, from the storage device, and delivering the read-out part of the master file to the terminal through the communications network as the object file.

As one preferred feature, the image delivery method further comprises the steps of: at the delivery source, (c) upon receipt of an object-file editing request of one individual user from the terminal, reading out a corresponding one of the plural parts of the master file, in which part the individual user appears, from the storage device based on the link information, and editing the read-out part of the master file; and (d) delivering the resulting part of the master file to the terminal as the edited object file.

As another preferred feature, the image delivery method further comprises the step of: at the delivery source, (e) erasing the corresponding one of the plural parts of the master file stored in the image storage means, in which part the individual user appears, after the edited object file has been delivered to the terminal in the delivering step (d).

As still another preferred feature, in the reading and delivering step (b), an image delivering rate is controlled in terms of the number of image frames per second in accordance with a condition of connection of the terminal with the communications network.

As another generic feature, there is provided an image delivery method for delivering an object moving-visual-image file (hereinafter called the object file) from a server to a client communicably connected to the server through a communications network, which method comprises the steps: at the server, (a) rendering the client to display, on a display screen of the client, a message asking a user to input user identification information on the client; (b) rendering the client to display, on the display screen of the client, a title or titles of one or more master moving-visual-image files (each hereinafter called the master file) linked with the last-named user identified by the input user identification information, each master file containing individual moving visual images of a plurality of users including the last-named user and being previously obtained by videoing the plural users substantially continuously and stored in a storage device, which is a component of the server or an external element communicably connected with the server; and (c) upon receipt of an object-file delivery request, which designates the title of a particular one of the plural master files, of the last-named user from the client, (c1) reading out a corresponding one of the plural parts of the particular one master file, in which part the last-named user appears, from the storage device based on both the designated title of the particular one master file and time codes representing a location or a set of locations of the corresponding part of the particular one master file and stored in the storage device, and (c2) rendering the client to display the read-out part of the particular one master file on the display screen of the client as the object file.

As still another generic feature, there is provided an image delivery method for delivering an object moving-visual-image file (hereinafter called the object file) from a server to a client communicably connected to the server through a communications network, which method comprises the steps of: at the server, (a) rendering the client to display, on a display screen of the client, a message asking a user to input user identification information on the client; (b) rendering the client to display, on the display screen of the client, (i) a title or titles of one or more master moving-visual-image files (each hereinafter called the master file) linked with the last-named user identified by the input user identification information, each master file containing individual moving visual images of a plurality of users including the last-named user and being previously obtained by videoing the plural users substantially continuously, each the master file being composed of a plurality of parts in which the plural users respectively appear and being stored in a storage device, which is a component of the server or an external element communicably connected with the server, and (ii) a plurality of predetermined editing ways for designation and selection by the last-named user; (c) upon receipt of an object-file editing and delivery request, which designates the title of a particular one of the plural master files and selects a desired one of the plural predetermined editing ways, of the last-named user from the client, (c1) reading out a corresponding one of the plural parts of the particular one master file, in which part the last-named user appears, from the storage device based on both the designated title of the particular one master file and time codes representing a location or a set of locations of the corresponding part of the particular one master file, (c2) editing the read-out corresponding part of the particular one master file in the selected editing way, and (c3) rendering the client to display the resulting part of the particular one master file on the display screen of the client as the edited object file.

As one preferred feature, the image delivery method further comprises the steps of: at the server, (d) rendering the client to display, on the display screen of the client, a message asking the user if the resulting moving visual image of the edited object file is approved by the user; and (e) upon receipt of the approval of the edited object file from the client, downloading the edited object file to the client.

As a further generic feature, there is provided a recording medium in which an image delivery program for delivering an object moving-visual-image file (hereinafter called the object file) from a delivery source to a terminal communicably connected to the delivery source through a communications network is recorded, wherein the program instructs a computer at the delivery source to execute the steps of: (a) storing both (i) a master moving-visual-image file (hereinafter called the master file), which contains moving visual images of a plurality of users and was previously obtained by videoing the plural users substantially continuously, into a storage device, which is a component of the delivery source or an external element communicably connected with the delivery source, the master file being composed of a plurality of parts in which the respective users appear, and (ii) link information linking the plural parts with the respective users; and (b) upon receipt of an object-file delivery request of a user from the terminal, (b1) reading out a corresponding one of the plural parts of the master file, in which part the last-named user appears, from the storage device based on the link information stored in the storage device, and (b2) delivering the read-out corresponding one part of the master file to the terminal as the requested object file.

As one preferred feature, the program instructs the computer at the delivery source to execute the following added steps of: (c) upon receipt of an object-file editing request of one individual user from the terminal, (c1) reading out a corresponding one of the plural parts of the master file, in which part the individual user appears, from the storage device based on the link information, and (c2) editing the read-out part of the master file; and (d) delivering the resulting part of the master file to the terminal as the edited object file.

As another preferred feature, the program instructs the computer at the delivery source to further execute the step of (e) erasing the corresponding one of the plural parts of the master file stored in the image storage means, in which part the individual user appears, after the edited object file has been delivered to the terminal.

As still another preferred feature, the program instructs the computer at the delivery source to control, in the reading and delivering step (b), an image delivering rate in terms of the number of image frames per second in accordance with a condition of connection of the terminal with the communications network.

As one additional generic feature, there is provided a recording medium in which an image delivery program for delivering an object moving-visual-image file (hereinafter called the object file) from a server to a client communicably connected to the server through a communications network is recorded, wherein the program instructs a computer at the server to execute the steps of: (a) rendering the client to display, on a display screen of the client, a message asking a user to input user identification information on the client; (b) rendering the client to display, on the display screen of the client, a title or titles of one or more moving-visual-image master files (each hereinafter called the master file) linked with the last-named user identified by the input user identification information for designation by the last-named user, each master file containing individual moving visual images of a plurality of users including the last-named user and previously obtained by videoing the plural users substantially continuously and stored in a storage device, which is a component of the server or an external element communicably connected with the server; and (c) upon receipt of an object-file delivery request, which designates the title of a desired one master file, of the last-named user from the client, each the master file being composed of a plurality of parts in which the respective users appear, (c1) reading out a corresponding one of the plural parts of the desired one master file, in which part the last-named user identified by the input user identification information appears, from the storage device based on both the designated title of the particular one master file and time codes representing a location or a set of locations of the corresponding one part of the desired one master file, and (c2) rendering the client to display the read-out corresponding part of the desired master file on the display screen of the client as the object file.

As a still additional generic feature, there is provided a recording medium in which an image delivery program for delivering an object moving-visual-image file (hereinafter called the object file) from a server to a client is recorded, wherein the program instructs a computer at the server to execute the steps of: (a) rendering the client to display, on a display screen of the client, a message asking a user to input user identification information on the client; (b) rendering the client to display, on the display screen of the client, (i) a title or titles of one or more master files (each hereinafter called the master file) linked with the last-named user identified by the input user identification information, each master file containing individual moving visual images of a plurality of users including the last-named user and being previously obtained by videoing the plural users substantially continuously and stored in a storage device, which is a component of the server or an external element communicably connected with the server, and (ii) a plurality of predetermined editing ways for designation and selection by the last-named user; and (c) upon receipt of an object-file editing and delivery request, which designates the title of a particular one master file and selects a desired one of the plural predetermined editing ways, of the last-named user from the client, (c1) reading out a corresponding one of the plural parts of the particular one master file, in which part the last-named user appears, from the storage device based on the designated title of the particular one master file and time codes representing a location or a set of locations of the corresponding one part in which the last-named user appears, (c2) editing the read-out part of the particular one master file in the selected predetermined editing way, and (c3) rendering the client to display the resulting part of the particular one master file object on the display screen of the client as the edited object file.

As one preferred feature, the program instructs the computer at the server to execute the following added steps of: (d) rendering the client to display, on the display screen of the client, a message asking the user if the edited object file is approved by the user; and (e) upon receipt of the approval of the edited object file from the client, downloading the requested edited object file to the client.

An image delivery system and method, and a computer-readable recording medium in which an image delivery program is recorded of the present invention, guarantee the following advantageous results:

If employed in leisure facilities, such as theme parks, and aquariums, and megastores, the image delivery system and method would not only make it possible to take video images of users at such places, but also make it possible to edit the video images in accordance with preferences of the users, with prior checking (browsing) by the users of what the video images have actually recorded. Hence, video images that comply with the users' wishes both in contents and in quality can be supplied to the users, hopefully resulting in a high level of customer satisfaction.

In this manner, with video images sufficient both in contents and in quality to satisfy users, it would be possible to realize a brand-new business selling video images that have been shot at leisure facilities, such as theme parks and aquariums, and at megastores, through the Internet.

Further, since a part in which a user is recorded is erased (deleted) from an original master file, it is possible to reduce the amount of data of the original master file, thereby saving resources.

Furthermore, the present invention yields another feature of controlling the quality of video images shown (replayed) on the displays of clients by controlling image delivering rates.

Other objects and further features of the present invention will be apparent from the following detailed description when read in conjunction with the relevant accompanying drawings.

### BRIEF DESCRIPTION OF THE DRAWINGS

FIG. 1 is a block diagram schematically showing an image delivery system of one embodiment of the present invention;

FIG. 2 is a schematic depicting an automated videoing system connected with the image delivery system of FIG. 1;

FIG. 3 is a diagram illustrating an example of the data structure of link information of one embodiment of the present invention;

FIG. 4A is a table indicating an example of an image file management manner of one embodiment of the present invention, which example employs a link management table;

FIG. 4B is a table indicating another example of the image file management manner of one embodiment of the present invention, which example employs a group management table;

FIG. 5 is a chart indicating parts, in which individual users' images are recorded, of a master video file stored in an image storage unit of an image delivery system of one embodiment of the present invention;

FIG. 6 is a table showing an example of customer information stored in a customer information management unit of an image delivery system of one embodiment of the present invention;

FIG. 7 is a flowchart illustrating a procedure (image delivery method) for delivering video images, while the images are being browsed, executed by an image delivery system of one embodiment of the present invention;

FIG. 8 is a flowchart illustrating a procedure (image delivery method) for delivering video images, when image editing is performed, executed by an image delivery system of one embodiment of the present invention; and

FIG. 9 is a conceptual outline of a form of business to which an image delivery system of one embodiment of the present invention is applied.

### DESCRIPTION OF THE PREFERRED EMBODIMENT(S)

One preferred embodiment of the present invention will be described hereinbelow with reference to the relevant accompanying drawings.

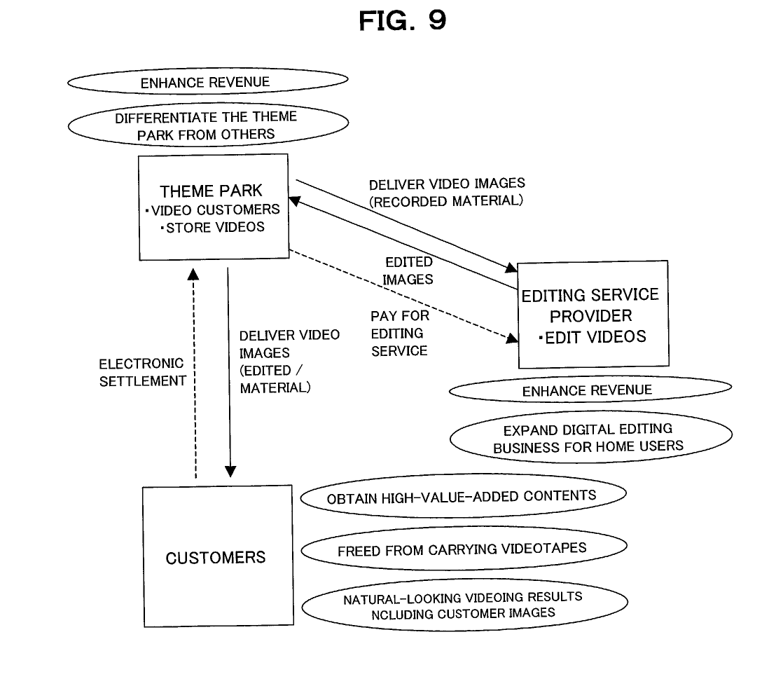

Firstly, a description will be made of a general outline of a business which is realized by utilizing the present invention, with reference to FIG. 9.

As shown in FIG. 9, by applying the present invention to leisure facilities, such as theme parks and aquariums, and also to megastores, it would be possible to realize a new business (contents business) form in which video images (contents) of users (customers), which have been automatically obtained at such places as those described above, are sold over the Internet. The following descriptions are for the present invention being applied to a theme park.

In this business, as shown in FIG. 9, a theme park-running company (hereinafter simply called a “theme park”) videos users enjoying attractions in the theme park at several positions inside the attractions. The video images thus shot are accumulated.

After that, if a user accesses the homepage of the theme park, requesting to browse the video images, the parts of a master video file, in which part the user appears, are extracted and delivered to the user.

If the user, who has browsed the video images, asks for delivery of the individual video images, the video images (material) are delivered to the user. In that case, payment for the delivery might be made by, for example, electronic settlement. The settlement method should by no means be limited to this, and other methods may also be applicable.

Otherwise, if the user asks for two or more video images to be edited, the parts in which the user appears are extracted from accumulated plural video images. The thus extracted plural video images are edited in accordance with the user's request, and the edited video images are delivered to the user. In this case, the payment for the delivery might be made by, for example, electronic settlement. The settlement method should by no means be limited to this, and other methods may also be applicable.

In this example, though the editing of the plural video images can be carried out by the theme park, any specialized editing service provider may be involved, thereby making it possible to enrich the variation of editing service, so that higher-value-added contents can be created.

At that time, if a user asks for plural video images to be edited, the theme park extracts the parts in which the user appears from the plural video images (material) being accumulated, and transmits the extracted parts to the editing service provider. In the meantime, the editing service provider edits the plural video images, which have been transmitted from the theme park, according to the user's requests, and then the edited video images are sent back to the theme park. The theme park then delivers the edited video images to the user. In this case, the user pays the theme park for the video image delivery by, for example, electronic settlement, and the theme park pays the editing service provider for the editing service (by electronic settlement, for example).

This business would allow theme parks to earn charges for delivering video images (contents), resulting in increased revenue of the theme parks. In particular, since such contents are for sale not on the days when users visit a theme park but on the following days, it could be expected that the users' purse strings be somewhat loosened, so that the sales of the contents are increased in comparison with in the case where they are sold at the theme park immediately after the users have already spent significant amounts of money. Further, this kind of distinctive contents business would differentiate a theme park from others.

From users' viewpoints, it is possible for users to visually check video images before purchasing them through the Internet, and it is also possible to select the preferred ones of the images to purchase and to edit plural images according to the users' requests. As a result, users are able to obtain not only natural-looking videoing results containing their images, but also higher-value-added image contents in which special images, which are unique to the theme park and unavailable anywhere else, and descriptions of attractions are incorporated. Moreover, users are able to obtain video images (contents) through the Internet, and are thereby freed from the inconvenience of carrying videotapes containing images shot at the theme park.

Here, with editing service providers involved in the contents business, it would be possible to expand digital image editing business for home users. Existing editing service providers could move into this newly established business, thereby acquiring increased revenues.

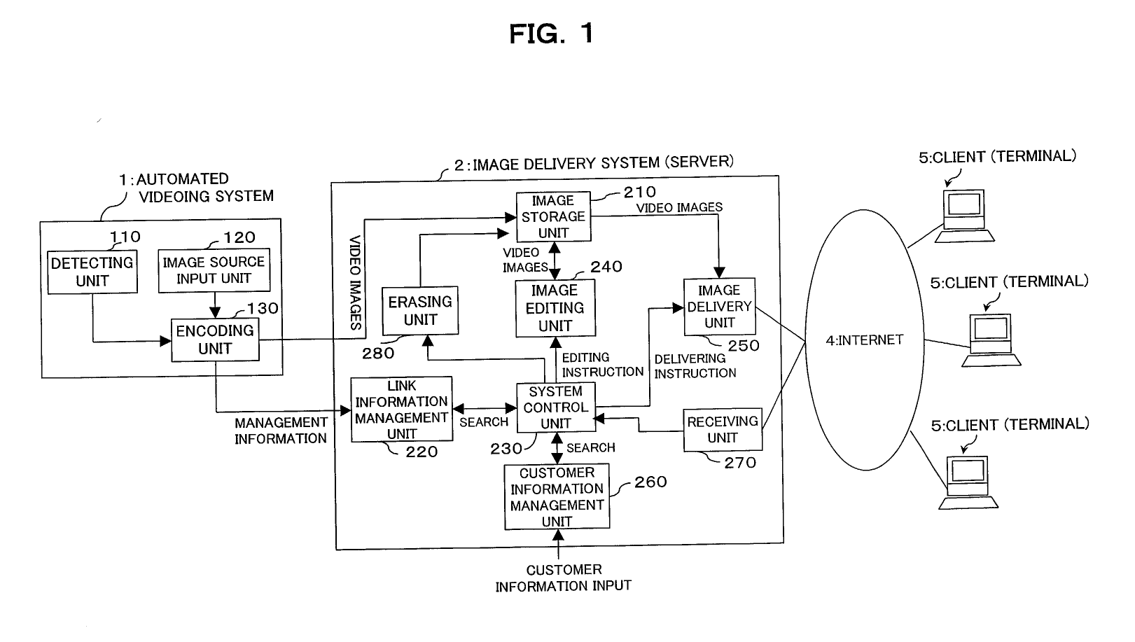

Referring now to FIG. 1 through FIG. 8, a description will be made hereinbelow of an image delivery system, an image delivery method, and a computer-readable recording medium in which an image delivery program is stored, according to one embodiment of the present invention. The present embodiment will show an example where the present system is applied to a theme park.

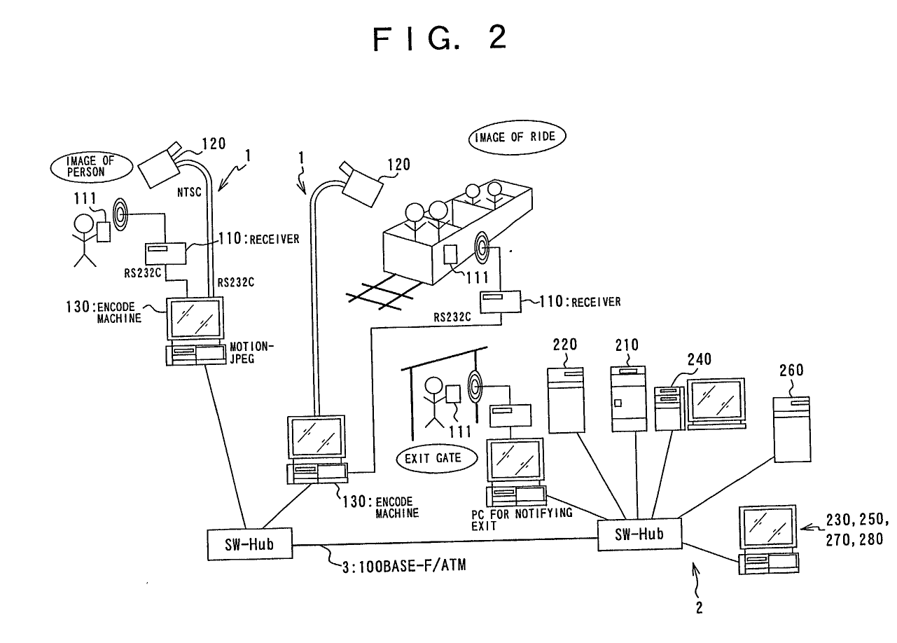

Referring now to FIG. 2, there are installed one or more automated videoing systems 1 at attractions in a theme park. Automated videoing system 1 and server (image delivery system) 2, which is provided at, for example, an Internet data center, are communicably connected through an information transmission path (communications network) 3. Further, as shown in FIG. 1, server 2, which is connected with multiple clients (terminals, user terminals) 5 through the Internet 4, is given a function of delivering video images to client 5. For this reason, this server 2 itself is sometimes called an image delivery system. Note that automated videoing system 1 and server (image delivery system) 2 are hereinafter called a “theme park-side system”.

Automated videoing system 1 installed in an attraction automatically videos users (customers) enjoying the attraction, and the video data (hereinafter also called video file) (moving-visual-image file) is transmitted in sequence to server 2 to be accumulated therein. When a user (client) accesses server 2 via the Internet 4 to request delivery of the video images (moving-visual-images), server 2 delivers the video images to the user.

Here, automated videoing system 1, as shown in FIG. 2, includes receiver (detecting unit) 110, which receives radio signals from card-type radio transmitter 111, video camera (image source input unit) 120, which shoots users as the subjects of video images, and encode machine (encoder, encoding unit) 130, which encodes the video images of the users in conjunction with receiver 110 and video camera 120. The receiver 110, video camera 120, and encoding unit 130 are interconnected via their dedicated interfaces (for example, NTSC video signals, RS232C, USB, IEEE1364, or others).

Here, inside the attraction, images of plural zones are shot by plural video cameras 120. Referring now to FIG. 2, there are prepared a couple of shooting zones: an individual user image-shooting zone where users entering the attraction are videoed and a ride image-shooting zone where users enjoying the ride are videoed. In this instance, receiver 110, video camera 120, and encode machine 130 are installed in each of the two zones. At the exit gate, receiver 110 and an exit-notifying PC are installed so as to detect that users have finished using the attraction.

While a user (subject to be videoed) is in one of the above zones, receiver 110 receives radio signals (containing information such as an identification (ID) code, and so on) from a radio transmitter 111 that the user carries, and then notifies encode machine 130 of the ID code (user ID, ID Number, customer ID) uniquely assigned to the user. In this example, if a user who wishes to use the image delivery service applies for it, radio transmitter 111 is lent to the user.

Upon receipt of the notification from receiver 110, encode machine 130 captures the video image input from video camera 120, in which image a user appears, and then encodes the image, thereby creating a video file. In addition, encode machine 130 generates the information (hereinafter called “link information”) that is made up of a set of a user ID, a video file identifier, and data (time codes) of the time of shooting the video image, which information associates a video file with a user who is recorded in the video file.

For this purpose, encode machine 130 has a function of encoding (into a Motion JPEG format, for example) a video image, in which a user appears, input from video camera 120, thereby creating a video file.

Encode machine 130 also has a function of automatically generating the information (link information) which associates the data (for example, video file names such as “A0001.Mov,” “A002.Mov,” and “A003.Mov,” . . . stored in the above-mentioned storage area) specifying the location of a user-recorded video data (video file) with the time (time code) when the user image was shot.

In this example, since descriptions are being made on the assumption that the present system is employed in a theme park, it is expected that a number of users (customers) enter one single zone successively, so that a resulting video file will contain encoded images recording two or more users in succession.

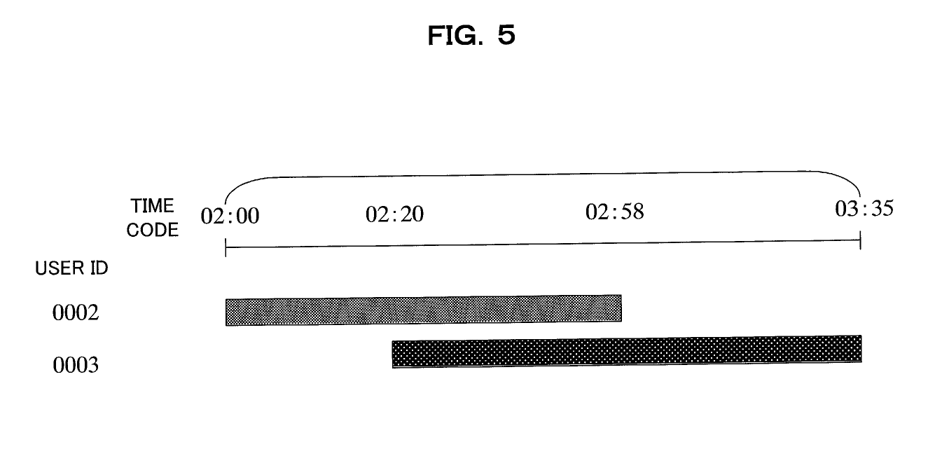

Referring now to FIG. 5, for example, assuming that a user given user ID 0002 and another user given user ID 0003 enter successively, the former one (ID 0002) is videoed from time code 02:00 through 02:58, and videoing must be continued until time code 03:35 for the latter one (ID 0003), even after time code 02:58. As a result, videoing is performed from time code 02:00 through 03:35 continuously, and this continuous video image is then encoded to create a video file.

In this manner, if two or more users are detected concurrently in the same zone, videoing is continued until the last user's image has been obtained, and then link information is generated in such a manner that one and the same video file name is shared by those plural users, while different sets of time codes are given, one for each of the users.

At that time, encode machine 130 should have enough storage capacity enough to hold video data (video file) and link information temporarily, only during the period before they are sent out, thereby realizing a rather inexpensive system construction. Further, since encode machine 130 operates independently from server (image delivery system) 2, it is possible to reduce the loads on the system.

The video file and the link information created by automated videoing system 1 thus constructed, are transferred to server (image delivery system) 2 over information transmission path 3, and then accumulated (stored) in a predetermined storage area (say, video server) of server 2 in such a manner that the files and link information would be identifiable later.

Referring now to FIG. 2, automated videoing system 1 and server (image delivery system) 2 are interconnected via a high-speed LAN (say, 10BASE-F, 100BASE-F) that employs an information transmission path (say, Asynchronous Transfer Mode (ATM)) with a speed high enough to transmit certain units of image data (video data), such as transmission frames and data files that have been encoded by automated videoing system 1.

Referring now to FIG. 1 and FIG. 2, there will be given a description of server 2, which serves as an image delivery system, according to the present embodiment.

As shown in FIG. 1 and FIG. 2, server 2, which serves as an image delivery system of the present embodiment, includes the following: image storage unit (video server) 210 for accumulating/storing video files which are transmitted from automated videoing system 1; link information management unit (link information management database) 220 for managing link information that specifies in which part of each video file in image storage unit 210 each of the users is recorded; system control unit (system controller) 230 for not only searching link information management unit 220 and customer information management unit 260 but also making instructions to image editing unit 240 and image delivery unit 250; image editing unit 240 for editing plural pieces of video data based on an editing program; image delivery unit 250 for delivering video files and edited video files (edited object files), in response to browsing requests (delivery requests) and editing requests (delivery requests), respectively, from clients 5; customer information management unit (customer information management database) 260 for managing information about an Internet-connection environment of every user; receiving unit 270 for receiving instructions from clients 5; and erasing unit 280 for erasing edited files and video files.

Among these, image storage unit 210 is connected to encode machine 130 of automated videoing system 1 via a high-speed communications network such as an ATM-LAN, so as to sequentially store video files which are transferred from automated videoing system 1. Hence, image storage unit 210 is equipped with a storage capacity sufficient to store such video files to be transferred. Here, note that Japanese Unexamined Patent Application Publication No. 7-261903 discloses a technique for transmitting JPEG-encoded video signals (NTSC, etc.) through an ATM network.

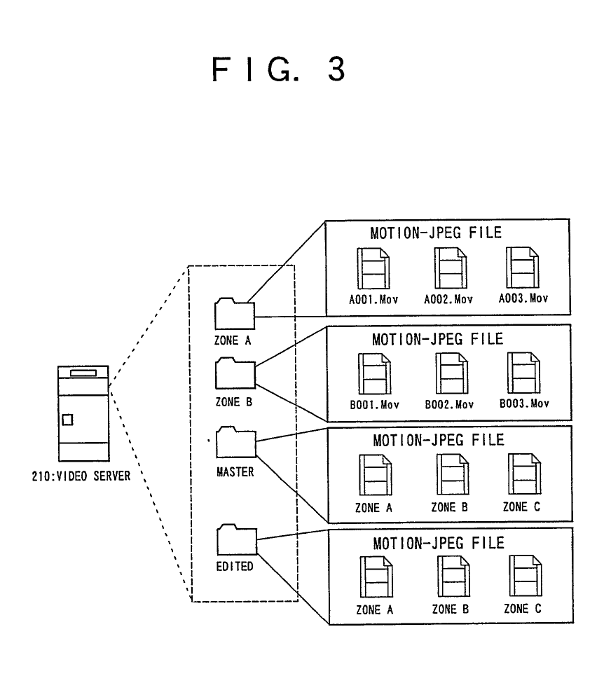

Referring now to FIG. 3, in image storage unit 210, video files which have been transferred from automated videoing system 1 are automatically sorted and then stored into folders prepared one for each type of video file. Video files stored in image storage unit 210 are given video file names (for example, “A001.Mov”, “A002.Mov”, “A003.Mov”, . . . ) unique to each of the video files, so that those files are distinguishable from one another.

In this example, descriptions are being made on the assumption that the present invention is applied to a theme park, and hence, it is expected that, a number of users (customers) successively enter one and the same zone prepared in a theme park attraction, so that a resulting video file often records images of numerous users continuously.

As a result, two or more users are recorded in one single video file. A resulting video file which has been created by encoding the video image recording the plural users successively, is stored as it is, without undergoing any processing. Upon receipt of a browsing request (delivery request) or an editing request (delivery request) from a user, only the part which corresponds to the user's time codes indicating the time when the user was shot, is extracted from the original video file, and only the extracted part, without duplication of the video file, is delivered (sent) to the user.

This is because a great amount of disc capacity would be necessitated, if video files (extracted part) prepared in advance, one for each user separately, were stored in image storage unit 210, or if such separate video files were generated, one for each user, upon receipt of browsing requests (delivery requests) or editing requests (delivery requests) from users. Accordingly, the above method would make fewer demands on resources.

Here, in the present embodiment, the part in which the corresponding user is recorded will be erased (deleted) after completion of editing processing (described later), so that the amount of data of the original video file is reduced, thereby making fewer demands on resources.

Next, link information management unit 220 is connected with encode machine 130 of automated videoing system 1 via a high-speed communications network such as an ATM-LAN, so as to sequentially store link information {video data and user information (video file name, user ID, time code, and so on) relevant to the video data} transferred from automated videoing system 1. Hence, link information management unit 220 is equipped with a storage capacity sufficient to store such link information to be transferred.

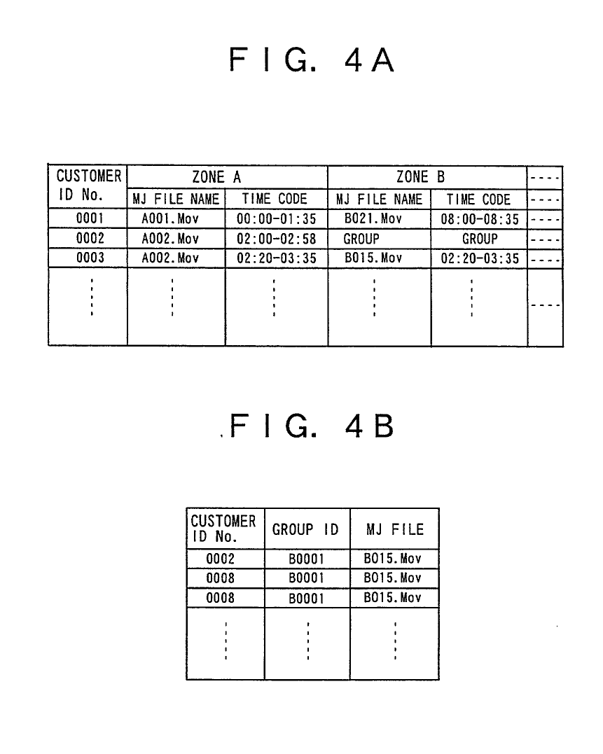

Referring now to FIG. 4A and FIG. 4B, a description will be made hereinbelow of an example of the data structure of link information. FIG. 4A shows an example of a link management table; FIG. 4B, an example of a group management table.

As shown in FIG. 4A, the link management table registers a set of a video file name (MJ file name) and time codes in association with a customer ID number, separately for every zone, thereby making it possible to specify the corresponding video file name and the time codes based on the customer ID number.

If two or more users register as one group so as to obtain video images in which those users are shot together, a group management table of FIG. 4B is referred to. For example, as shown in FIG. 4A, if the term, “group”, is written in columns titled “video file name” and “time code”, the group management table of FIG. 4B must be referred to, in order to specify a video file name based on a group ID No. and also to specify time codes based on a customer ID No. In this manner, when two or more users belong to the same group (in this case, the users are given one and the same group ID No.), the same video file will be referred to.

Next, customer information management unit 260 stores, for example, information about users (user information), such as their contact addresses and others, and also information about users' Internet-connection environment (communications rate, access line type, maximum allowable bandwidth, and others), as customer information.

In this example, if a user makes a request to take the video image delivery service before using a theme park attraction, the user gives his/her personal information (user information), such as their contact addresses and others, and also information about users' Internet-connection environment (communications rate, access line type, maximum allowable bandwidth, and others), as customer information. Such information is input from a terminal connected with server 2, which serves as the image delivery system, via a communications network, and is then transmitted to customer information management unit 260 of server 2, thereby being stored in customer information management unit 260.

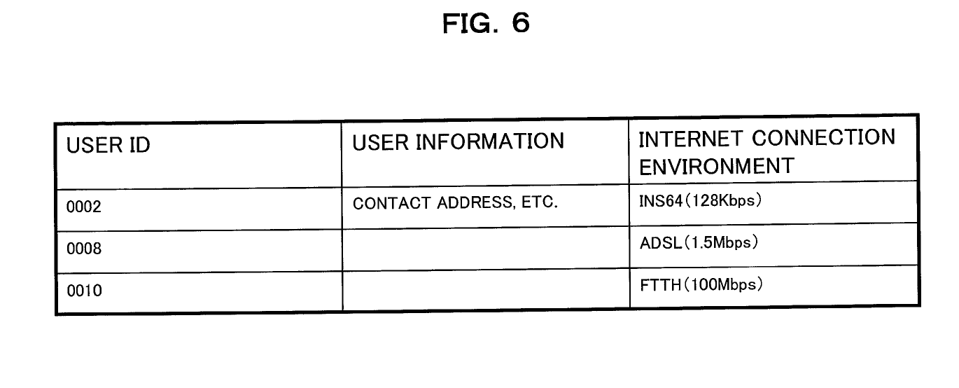

More precisely, with reference to FIG. 6, customer information management unit 260 stores information about users (user information), such as their contact addresses and others, and also information about users' Internet-connection environment, such as access line types {say, INS64 (128 Kbps), ADSL (1.5 Mbps), and FTTH (100 Mbps)} (communications rate, maximum allowable bandwidth).

After that, system control unit (system controller) 230, upon receipt of a browsing request (delivery request) from a user (client) via receiving unit 270, retrieves and reads-out the user's link information (video file name, time codes) from link information management unit 220 based on the user's ID code, and also retrieves and reads-out the user's Internet-connection environment (maximum allowable bandwidth) from customer information management unit 260, and then, the thus read-out link information and Internet-connection environment are output to image delivery unit 250, thereby executing a function for making a delivery instruction (transmission instruction) to image delivery unit 250.

Further, system control unit 230, upon receipt of an editing request from a user (client) via receiving unit 270, creates an editing program based on the editing request of the user, and then outputs the thus created editing program to image editing unit 240, thereby executing a function for making an editing instruction to image editing unit 240.

More precisely, upon receipt of an editing request from a user, system control unit 230 extracts the parts, in which the user appears, of video files (master files) stored in image storage unit 210, based on image file names and time codes. A sequence of instruction codes (editing program) is then generated, which indicates in what sequence the extracted parts should be arranged and what kind of image processing should be added. The thus generated editing program is transferred to image editing unit 240 immediately.

After that, image editing unit 240 carries out a function for editing plural video files, following the editing program.

More precisely, upon receipt of editing instructions from system control unit 230, image editing unit 240 searches image storage unit 210 based on the user-selected video file names and time codes, following the editing program, and retrieves/reads-out the parts, in which the user appears, of the corresponding video files.

Referring now to FIG. 5, on the assumption that a video file with video file name “A002.mov” records videoed images (moving-visual-images) of two users (the one with user ID 0002 and the other with user ID 0003; hereinafter simply called user ID 0002 and user ID 0003, respectively), if user ID 0002 selects a video file with video file name A002.mov (hereinafter simply called video file A002.mov) at issuance of an editing request, the part of video file A002.mov corresponding to time codes 02:00 through 02:58 is read-out. Meanwhile, if user ID 0003 selects video file A002.mov, at issuance of an editing request, the part of video file A002.mov corresponding to time codes 02:20 through 03:35 is read out.

In response to a request from a user (client), image editing unit 240 reads-out both an existing video file, which has been previously stored in image storage unit 210, and a material-storing file, which records the contents to be used in common among plural video files, such as the description of the theme park and composite images (titles, dates, and soon) including predetermined character strings, graphics, and others.

Image editing unit 240 then combines one or more master video files in which the user is recorded, the above-mentioned existing video file, and the material-storing file, which records composite images (titles, dates, and so on) including predetermined character strings, graphics, and others, in accordance with the editing program and the given sequence, so as to create an edited video file (edited object file). This edited video file, as a file separate from the original video files (master files), is temporarily stored in a predetermined storage area of image storage unit 210 with an identifiable file name having been automatically given. The editing process carried out by image editing unit 240 includes image processing that the user himself/herself adds to the recorded video images.

As described above, since system control unit 230 and image editing unit 240 edit video files in a coordinated fashion, these units are called, in combination, an image editing control means.

Further, in response to a browsing request (delivery request) from a user (client), image delivery unit 250 receives a delivery instruction (transmission instruction) from system control unit 230, and in response to the instruction, extracts only the parts in which the user appears, of the video files stored in image storage unit 210, according to link information (image file names and time codes). Image delivery unit 250 then delivers (transmits) the video file to the user via the Internet 4, controlling an image delivering rate in terms of the number of image frames per second in accordance with the Internet-connection environment (maximum allowable bandwidth) of the user (that is, Internet-connection environment of client 5).

Referring now to FIG. 5, for example, on the assumption that video file A002.mov records videoed images (moving-visual-images) of two users (user ID 0002 and user ID 0003), if user ID 0002 makes a browsing request (delivery request) of video file A002.mov, the part of video file A002.mov corresponding to time codes 02:00 through 02:58 is extracted, and is then sent out, while being controlled in image delivering rate. Meanwhile, if user ID 0003 makes a browsing request (delivery request) of video file A002.mov, the part of video file A002.mov corresponding to time code 02:20 through 03:35 is extracted, and is then sent out at a controlled image-delivering rate.

Further, in response to an editing request from a user (client), image delivery unit 250 receives a delivery instruction from system control unit 230. Image delivery unit 250, responsive to the instruction, then reads-out the edited file stored in image storage unit 210 and delivers the edited video file to the user via the Internet 4, controlling image delivering rate in terms of the number of image frames per second in accordance with the Internet-connection environment (maximum allowable bandwidth) of the user.

In the present embodiment, image delivery unit 250 is also given a function to read-out information about Internet-connection environment (maximum allowable bandwidth) of a user, which information is stored in customer information management unit 260. On the basis of this information, image delivery unit 250 controls an image delivering rate in terms of the number of image frames per second, thereby managing the quality of the video image to be shown (replayed) on a display of the user (client).

In this manner, customer information management unit 260 stores information about the Internet-connection environment (access line type, maximum allowable bandwidth, communications rate, and others) of users. When sending out video files, transmission is performed at a video rate (the number of image frames per second) most appropriate for users according to their Internet-connection environment (maximum allowable bandwidth), and hence, it is no longer necessary to repeatedly create a separate video file which is adapted to the most appropriate video rate for each user, every time each video file is sent out.

This is because, if plural video files, which are adjusted in image delivery rate to match the users' Internet-connection environment, are created one for each user who is recorded in a master video file, this technique would cause increased demands on resources in image storage unit 210.

As described above, since system control unit 230 and image delivery unit 250 perform delivery of video files in a coordinated fashion, these units are called, in combination, an image delivery control means.

Erasing unit 280 erases (deletes) the following: edited files stored in image storage unit 210; original video files (master files) that have been used in editing; and the parts, in which a corresponding user is recorded, from the original files used in editing.

Erasing unit 280 erases (deletes) edited files and video files in accordance with erasing instructions received from system control unit 230. Here, after sending out an edited video file (edited file) to a user, system control unit 230 issues an erasing instruction to erasing unit 280.

Referring now to FIG. 5, on the assumption that video file A002.mov records videoed images (moving-visual-images) of two users, user ID 0002 and user ID 0003, after an edited file is sent out to user ID 0002, the part of video file A002.mov corresponding time codes 02:00 through 02:58 is erased, and the original file is updated by the video file having undergone the erasing process. Meanwhile, after an edited file is sent out to user ID 0003, the part of video file A002.mov corresponding to time codes 02:20 through 03:35 is erased, and the original file is updated by the video file having undergone the erasing process.

As described above, since erasing unit 280 and system control unit 230 edits video files in a coordinated fashion, these units are called, in combination, an erasing control means.

Taking into consideration the above-described construction of an image delivery system of the present embodiment, descriptions will be given hereinbelow of processing steps of the image delivery system, separately, with respect to two cases: one case where a browsing request (delivery request) reaches from a user; and another case where an editing request (delivery request) does so.

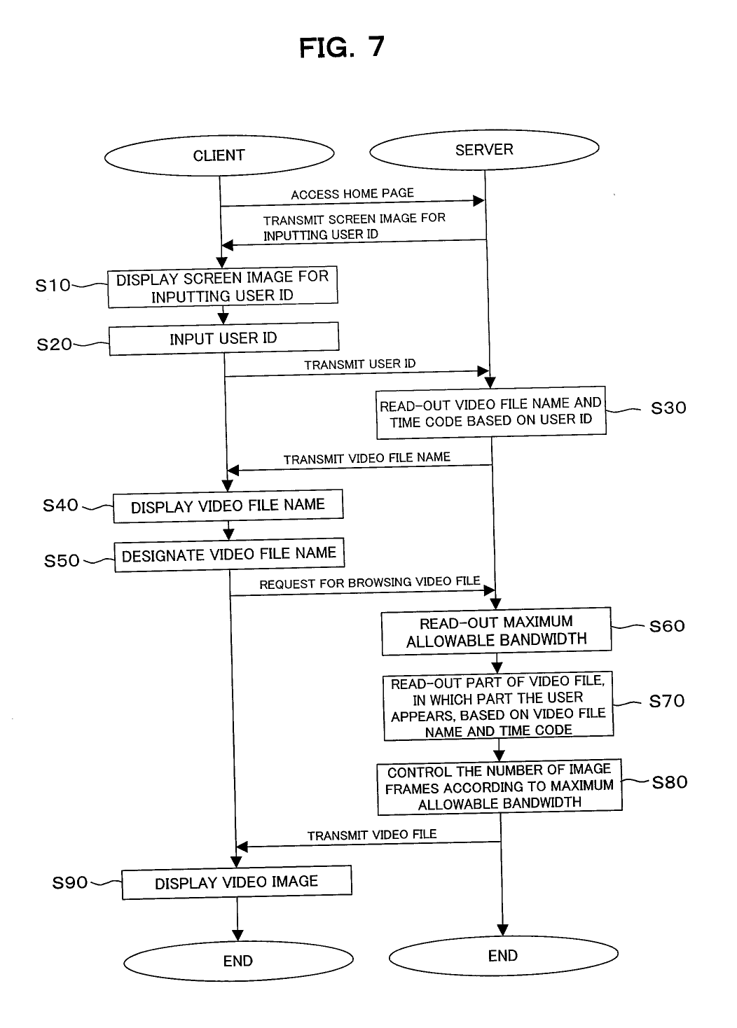

As a description of the former case, upon receipt of a browsing request (delivery request) from a user, the processing proceeds following the flowchart of FIG. 7.

In this case, the user accesses the theme park homepage stored in server 2 from client 5. System control unit 230 of server 2 then transmits an input screen image, through which an user ID (user identification information) is to be input, to client 5, and the input screen image is shown on a display (display means) of client 5 in, say, HTML (step S10).

After the user inputs an authorized user ID and then makes a transmission instruction (step S20), the input user ID is notified to system control unit 230 of server 2.

Upon receipt of the user ID notification, system control unit 230 retrieves a corresponding video file name and time codes from link information management unit 220, using the user ID as a key (step S30). System control unit 230 transmits the retrieved video file name to client 5, and the video file name is shown on a display of client 5 in, say, HTML (step S40). If two or more video files are retrieved, in which files the user appears, there are shown two or more video file names on the display of client 5.

At that time, users' passwords can be stored in customer information management unit 260 of server 2 in association with user IDs. Upon receipt of a user ID and a password from a user, system control unit 230 of server 2 searches customer information management unit 260 to evaluate whether or not the user ID and the password agree, thereby verifying the user. If the evaluation yields a negative result, an error message should be issued.

Next, the user, using the HTML descriptions, selects a desired one (or more; the following description will be made, for convenience, of a case where a single video file is selected) of the plural video files shown on the display of client 5, and issues a request for browsing the selected/designated file (step S50). The video file-browsing request is sent from client 5 to system control unit 230 of server 2.

Upon receipt of the video file-browsing request, system control unit 230 of server 2 searches customer information management unit 260, and retrieves the maximum allowable bandwidth of the corresponding user as the user's Internet-connection environment, based on the user ID (step S60).

System control unit 230 then outputs to image delivery unit 250 the designated video file name, the time codes, and the maximum allowable bandwidth, and instructs image delivery unit 250 to deliver the video file based on these outputs.

Upon receipt of the delivery instruction from system control unit 230, image delivery unit 250 reads-out only the part of the video file in image storage unit 210 in which the user is recorded, based on the designated video file name and time codes (these time codes indicate the beginning and the end of the user-recorded part) (step S70).

Image delivery unit 250 then sends out the read-out video file (user-recorded part) to client 5, controlling an image delivering rate in terms of the number of image frames per second (step S80) in accordance with the maximum allowable bandwidth of the user, as the user's Internet-connection environment. The thus delivered video image of the user is displayed on the display of client 5 (step S90).

More concretely, if a user accesses the Internet through a broadband connection service, a high-quality video file can be delivered. If an ISDN connection is used, the quality of the video file being transmitted would be intermediate. Otherwise, if the user accesses the Internet through an analog modem, the quality of the video file transmitted would be lowered considerably.

In this manner, users are able to browse video files stored in server 2 from client 5 via the Internet 4. If the users request such video files to be delivered, the procedure for purchasing the video files is executed, in response to the user's delivery request, and the corresponding video files are delivered to client 5 to be downloaded thereto.

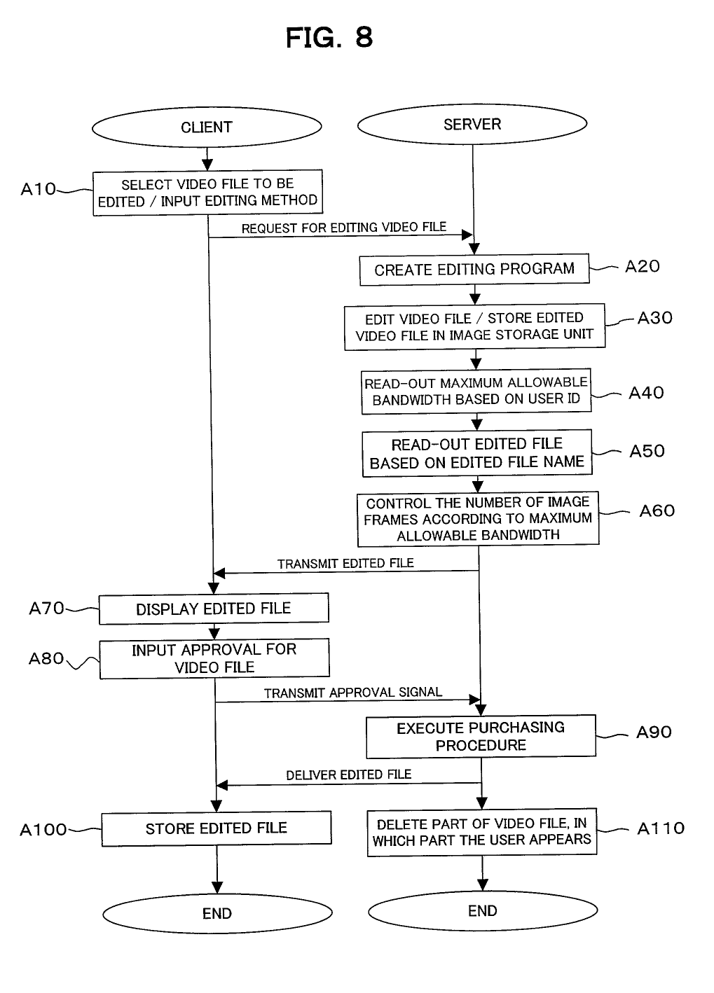

Referring now to FIG. 8, there will be given, following the flowchart illustrated therein, a description of the processing carried out in response to the receipt of an editing request (delivery request) from a user.

First of all, following the above-described steps to be carried out at receipt of a browsing request, video file names are shown on a display of client 5 in, say, HTML (see step S10 through step S40 of FIG. 7).

Next, the user, using the HTML descriptions, selects a desired one or more of the plural video files shown on the display of client 5, and issues a request for editing the selected/designated files concurrently with the input of the method of editing (details for editing) (step A10). The video file-editing request is sent from client 5 to system control unit 230 of server 2.

Here, as such editing methods, for example, it is possible to designate the sequence of arranging the selected video files, and also, it is possible to select material-storing files, which record the contents to be commonly used among plural video files, such as the description of the theme park and composite images (titles, dates, and so on) including predetermined character strings, graphics, and others.

System control unit 230 of server 2 generates an editing program according to the editing request from the user, which program is then output to image editing unit 240 to make editing instructions (step A20).

More precisely, upon receipt of the editing request from the user, system control unit 230 extracts the parts, in which the user appears, of video files (master files) stored in image storage unit 210, based on image file names and time codes. A sequence of instruction codes (editing program) is then generated, which indicates in what sequence the extracted parts should be arranged and what kind of image processing should be added. System control unit 230 transfers the thus generated editing program to image editing unit 240 immediately, thereby issuing editing instructions to image editing unit 240.

Upon receipt of the editing instructions from system control unit 230, image editing unit 240 carries out the function for editing video files, following the editing program (step A30).

In more detail, image editing unit 240 searches image storage unit 210 based on the user-selected video file names and time codes, following the editing program, and retrieves/reads-out the parts, in which the user appears, of the corresponding video files.

Under the instruction of the editing program, image editing unit 240 reads-out both an existing video file, which has been previously stored in image storage unit 210, and a material-storing file, which records the contents to be commonly used among plural video files, such as the description of the theme park and composite images (titles, dates, and so on) including predetermined character strings, graphics, and others.

Image editing unit 240, under the instruction of the editing program, then combines one or more video files which have been read-out in a given sequence and the existing video files, thereby creating an edited file. After completion of such editing, image editing unit 240 stores the edited video file, as an independent file, in some other storage area of image storage unit 210, and then notifies system control unit 230 of completion of the editing.

Upon receipt of the editing-completed notification, system control unit 230 retrieves Internet-connection environment (maximum allowable bandwidth) of the corresponding user, based on the user ID, from customer information management unit 260 (step A40). System control unit 230 then outputs to image delivery unit 250 the file name of the edited file (edited file name) and the Internet-connection environment (maximum allowable bandwidth), and instructs image delivery unit 250 to send out the edited file based on these outputs.

Image delivery unit 250, responsive to the delivery instruction from system control unit 230, reads-out the edited file from image storage unit 210, based on the designated edited file (step A50).

Image delivery unit 250 then sends out the read-out video file to client 5, controlling image delivering rate in terms of the number of image frames per second (step A60) in accordance with the maximum bandwidth allowed by the user's Internet-connection environment. The thus delivered video image of the user is displayed on the display of client 5 (step A70). At that time, on the display of client 5, a message asking for an approval for the edited video file is also shown.

In reply to this message, if the user checks the edited video image shown on the display of client 5, and then inputs his/her approval for the image (step A80), an approval signal is sent to system control unit 230 of server 2.

Upon receipt of the approval signal, system control unit 230 of server 2 carries out purchasing procedures to purchase the video file (step A90). After completion of the procedures, system control unit 230 delivers the edited file to client 5, thereby downloading the edited file to client 5 (step A100).

If users have broadband connections to the Internet, high-quality video files may be transmitted. Otherwise, in the case of ISDN connections, intermediate-class-quality video files will be transmitted, and in the case of analog modem connections, low-quality video files will be transmitted.

After completion of sending out an edited file, system control unit 230 issues an erasing instruction to erasing unit 280, which then erases (deletes) the edited file from image storage unit 210 and also erases (deletes) the part, in which the user (hereinafter also called the object user) appears, of the original master file that has been used in editing, thereby updating the original master file (step A110).

At this time, erasing unit 280 evaluates whether or not any other user (customer) appears (is recorded) in the original master file in image storage unit 210. If the evaluation yields a negative result, the video file recording the object user is erased.

Otherwise, if the evaluation yields a positive result, it is further evaluated whether or not anybody else, who was videoed at the same time, would like to purchase a video file. If the evaluation result is negative, the object user-recorded video file is erased. Otherwise, if the evaluation result is positive, only the part in which the object user is recorded is specified based on time codes, which part is then erased.

At that time, the user may be given an opportunity to decide whether to erase the user-recorded part. Upon receipt of the user's instruction to erase the part, erasing is carried out. Otherwise, the user-recorded part is erased with the elapse of a predetermined time period after editing has been completed.

Accordingly, with an image delivery system and method of the present embodiment employed in leisure facilities such as theme parks, aquariums, and megastores, it would be not only possible to take video images of users in such places, but it would also be possible to edit the video images in accordance with the preferences of the users, with prior checking (browsing) of what the video images actually record. Hence, video images complying with the users' wishes both in contents and quality, can be supplied to the users, thereby making the users significantly satisfied with the service.

In this manner, with the contents and the quality of video images sufficient to satisfy users, it is possible to realize a brand-new business to sell video images that have been shot at leisure facilities, such as theme parks and aquariums, and at megastores, through the Internet.

Further, since the part in which a user is recorded can be erased (deleted) from an original master file, it is possible to reduce the amount of data of the original master file, thereby making fewer demands on resources.

Still further, the present invention yields another feature of controlling the quality of video images shown (replayed) on the displays of the clients by means of controlling image delivering rates.

In this instance, delivering/browsing video files is performed via the Internet 4 in the above embodiment. The present invention should by no means be limited to this, and for example, one or more terminals (user terminals) 5 interconnected with image delivery system 2 via, say, a high-speed LAN may be installed in a theme park, so that users can browse/receive video files on this terminal 5. In this case, edited files should be written in recording media through terminal 5.

Further, the Internet 4 is employed, in the above embodiment, for browsing/editing video files, and also for downloading edited files (video files), which have been purchased through purchasing procedures, onto client 5. The present invention should by no means be limited to this. For example, if a user whishes to have an edited file recorded in a recording medium, image delivery system 2, upon receipt of the instruction of the user (client), stores an edited file in a recording medium, which is then delivered to the user by postal mail or courier service.

Furthermore, in practical use, an image delivery system (server) and method of the above embodiment are realized by executing an image delivery program for executing the above-mentioned varying functions, which program has been installed (set-up) in a computer.

The image delivery program is stored in advance in a computer-readable recording medium, which is then distributed on the market. In such a case, an image delivery program should be installed from a recording medium into a computer.

Here, such recording media include the following program-recordable media: memories such as semiconductor memories; magnetic discs; optical discs (CD-ROMs, etc.); magneto-optical discs (MOs); magnetic tapes; hard discs; flexible discs; IC cards; ROM cartridges; punch cards; internal storages of computers (memories such as RAM or ROM); and external storages. Additionally, various types of other computer-readable media can be utilized, such as printed matters on which any code system such as bar codes are printed. In this instance, CD-ROMs, MOs, magnetic tapes, and IC cards are also called portable recording media.

Furthermore, it is also possible to deliver an image delivery program over a network that serves as a transmission medium (communications path, communications network: for example, the Internet, and communications lines such as public circuits, dedicated circuits, and others), in which case an image delivery program itself is distributed in the market. More concretely, an image delivery program is previously uploaded onto a Web server which users access via the Internet to download the program, thereby making it possible to deliver an image delivery program to users.

As a result, with an image delivery program for instructing a computer to execute varying functions of the above-described image delivery system (or an image delivery program for instructing a computer to execute the steps of the above-described image delivery method) or a computer-readable recording medium recording this program therein, like effects and benefits to those of the above-described image delivery system and method would also be guaranteed.

An image delivery system and method, and a computer-readable recording medium in which an image delivery program is recorded, according to the present embodiment, should by no means be limited to this, and various changes or modifications may be suggested without departing from the gist of the invention.

What is claimed is:

1. An image delivery system for delivering an object moving-visual-image file (hereinafter called the object file) to a terminal communicably connected to said system through a communications network, said system comprising:
(a) image storage means for storing a master moving-visual-image file (hereinafter called the master file), containing individual moving visual images of a plurality of users and previously obtained by videoing the plural users substantially continuously;
(b) link information management means for storing link information linking a plurality of parts of said master file, which is stored in said image storage means, with the respective users; and
(c) image delivery control means, responsive to the receipt of an object-file delivery request of one individual user from said terminal, for reading out a corresponding one of the plural parts of said master file, in which part said one individual user appears, from said storage means, and delivering the read-out part of said master file to said terminal through the communications network as the object file.

2. An image delivery system according to claim 1, further comprising (d) image editing control means, responsive to the receipt of an object-file editing and delivery request of one individual user from said terminal, for reading out a corresponding one of the plural parts of said master file, in which part said one individual user appears, based on said link information, from said storage means, editing the read-out part of said master file, and delivering the resulting part of said master file to said terminal as the edited object file.

3. An image delivery system according to claim 2, further comprising (e) erasing control means for erasing the corresponding one of the plural parts of said master file stored in said image storage means, in which part said one individual user appears, after the edited object file has been delivered to said terminal.

4. An image delivery system according to claim 1, wherein said image delivery control means controls an image delivering rate in terms of the number of image frames per second in accordance with a condition of connection of said terminal with the communications network.

5. An image delivery system according to claim 2, wherein said image delivery control means controls an image delivering rate in terms of the number of image frames per second in accordance with a condition of connection of said terminal with the communications network.

6. An image delivery system according to claim 3, wherein said image delivery control means controls an image delivering rate in terms of the number of image frames per second in accordance with a condition of connection of said terminal with the communications network.

7. An image delivery method for delivering an object moving-visual-image file (hereinafter called the object file) from a delivery source to a terminal communicably connected to the delivery source through a communications network, said method comprising the steps of:
(a) storing both a master moving-visual-image file (hereinafter called the master file), which contains individual moving visual images of a plurality of users and was previously obtained by videoing the plural users substantially continuously, and link information linking a plurality of parts of said master file with the respective users, into a storage device, which is a component of the delivery source or an external element communicably connected with the delivery source; and
at the delivery source
(b) upon receipt of an object-file delivery request of one individual user from said terminal, reading out a corresponding one of the plural parts of said master file, in which part said one individual user appears, from the storage device, and delivering the read-out part of said master file to said terminal through the communications network as the object file.

8. An image delivery method according to claim 7, further comprising the steps of:
at the delivery source
(c) upon receipt of an object-file editing request of one individual user from said terminal, reading out a corresponding one of the plural parts of said master file, in which part said one individual user appears, from the storage device based on said link information, and editing the read-out part of said master file; and
(d) delivering the resulting part of said master file to said terminal as the edited object file.

9. An image delivery method according to claim 8, further comprising the step of: at the delivery source (e) erasing the corresponding one of the plural parts of said master file stored in said image storage means, in which part said one individual user appears, after the edited object file has been delivered to said terminal in said delivering step (d).

10. An image delivery method according to claim 7, wherein in said reading and delivering step (b), an image delivering rate is controlled in terms of the number of image frames per second in accordance with a condition of connection of said terminal with the communications network.

11. An image delivery method according to claim 8, wherein in each of said reading and delivering step (b) and said edited object file delivering step (d), an image delivering rate is controlled in terms of the number of image frames per second in accordance with a condition of connection of said terminal with the communications network.

12. An image delivery method according to claim 9, wherein in each of said reading and delivering step (b) and said edited object file delivering step (d), an image delivering rate is controlled in terms of the number of image frames per second in accordance with a condition of connection of said terminal with the communications network.

13. An image delivery method for delivering an object moving-visual-image file (hereinafter called the object file) from a server to a client communicably connected to the server through a communications network, said method comprising the steps:
at the server
(a) rendering the client to display, on a display screen of the client, a message asking a user to input user identification information on the client;
(b) rendering the client to display, on the display screen of the client, a title or titles of one or more master moving-visual-image files (each hereinafter called the master file) linked with the last-named user identified by the input user identification information, each master file containing individual moving visual images of a plurality of users including said last-named user and being previously obtained by videoing the plural users substantially continuously and stored in a storage device, which is a component of the server or an external element communicably connected with the server; and
(c) upon receipt of an object-file delivery request, which designates the title of a particular one of the plural master files, of said last-named user from the client, (c1) reading out a corresponding one of the plural parts of said particular one master file, in which part said last-named user appears, from the storage device based on both the designated title of said particular one master file and time codes representing a location or a set of locations of said corresponding part of said particular one master file and stored in the storage device, and (c2) rendering the client to display the read-out part of said particular one master file on the display screen of the client as the object file.

14. An image delivery method for delivering an object moving-visual-image file (hereinafter called the object file) from a server to a client communicably connected to the server through a communications network, said method comprising the steps of:
at the server
(a) rendering the client to display, on a display screen of the client, a message asking a user to input user identification information on the client;
(b) rendering the client to display, on the display screen of the client, (i) a title or titles of one or more master moving-visual-image files (each herein after called the master file) linked with the last-named user identified by the input user identification information, each master file containing individual moving visual images of a plurality of users including said last-named user and being previously obtained by videoing the plural users substantially continuously, each said master file being composed of a plurality of parts in which the plural users respectively appear and being stored in a storage device, which is a component of the server or an external element communicably connected with the server, and (ii) a plurality of predetermined editing ways for designation and selection by said last-named user;
(c) upon receipt of an object-file editing and delivery request, which designates the title of a particular one of the plural master files and selects a desired one of the plural predetermined editing ways, of said last-named user from the client, (c1) reading out a corresponding one of the plural parts of said particular one master file, in which part said last-named user appears, from the storage device based on both the designated title of said particular one master file and time codes representing a location or a set of locations of said corresponding part of said particular one master file, (c2) editing the read-out corresponding part of said particular one master file in the selected editing way, and (c3) rendering the client to display the resulting part of said particular one master file on the display screen of the client as the edited object file.

15. An image delivery method according to claim 14, further comprising the steps of:
at the server
(d) rendering the client to display, on the display screen of the client, a message asking the user if the resulting moving visual image of the edited object file is approved by the user; and
(e) upon receipt of the approval of the edited object file from the client, downloading the edited object file to the client.

16. A recording medium in which an image delivery program for delivering an object moving-visual-image file (hereinafter called the object file) from a delivery source to a terminal communicably connected to the delivery source through a communications network is recorded, wherein said program instructs a computer at the delivery source to execute the steps of:
(a) storing both (i) a master moving-visual-image file (hereinafter called the master file), which contains moving visual images of a plurality of users and was previously obtained by videoing the plural users substantially continuously, into a storage device, which is a component of the delivery source or an external element communicably connected with the delivery source, said master file being composed of a plurality of parts in which the respective users appear, and (ii) link information linking the plural parts with the respective users; and
(b) upon receipt of an object-file delivery request of a user from said terminal, (b1) reading out a corresponding one of the plural parts of said master file, in which part the last-named user appears, from the storage device based on said link information stored in the storage device, and (b2) delivering the read-out corresponding one part of said master file to said terminal as the requested object file.

17. A recording medium according to claim 16, wherein said program instructs the computer at the delivery source to execute the following added steps of:
(c) upon receipt of an object-file editing request of one individual user from said terminal, (c1) reading out a corresponding one of the plural parts of said master file, in which part said one individual user appears, from the storage device based on said link information, and (c2) editing the read-out part of said master file; and
(d) delivering the resulting part of said master file to said terminal as the edited object file.

18. A recording medium according to claim 17, wherein said program instructs the computer at the delivery source to further execute the step of (e) erasing the corresponding one of the plural parts of said master file stored in said image storage means, in which part said one individual user appears, after the edited object file has been delivered to said terminal.

19. A recording medium according to claim 16, wherein said program instructs the computer at the delivery source to control, in said reading and delivering step (b), an image delivering rate in terms of the number of image frames per second in accordance with a condition of connection of said terminal with the communications network.

20. A recording medium according to claim 17, wherein said program instructs the computer at the delivery source to control, in each of said reading and delivering step (b) and said delivering step (d), an image delivering rate in terms of the number of image frames per second in accordance with a condition of connection of said terminal with the communications network.

21. A recording medium according to claim 18, wherein said program instructs the computer at the delivery source to control, in each of said reading and delivering step (b) and said delivering step (d), an image delivering rate in terms of the number of image frames per second in accordance with a condition of connection of said terminal with the communications network.

22. A recording medium in which an image delivery program for delivering an object moving-visual-image file (hereinafter called the object file) from a server to a client communicably connected to the server through a communications network is recorded, wherein said program instructs a computer at the server to execute the steps of:
(a) rendering the client to display, on a display screen of the client, a message asking a user to input user identification information on the client;
(b) rendering the client to display, on the display screen of the client, a title or titles of one or more moving-visual-image master files (each hereinafter called the master file) linked with the last-named user identified by the input user identification information for designation by said last-named user, each master file containing individual moving visual images of a plurality of users including said last-named user and previously obtained by videoing the plural users substantially continuously and stored in a storage device, which is a component of the server or an external element communicably connected with the server; and
(c) upon receipt of an object-file delivery request, which designates the title of a desired one master file, of said last-named user from the client, each said master file being composed of a plurality of parts in which the respective users appear, (c1) reading out a corresponding one of the plural parts of said desired one master file, in which part said last-named user identified by said input user identification information appears, from the storage device based on both the designated title of said particular one master file and time codes representing a location or a set of locations of said corresponding one part of said desired one master file, and (c2) rendering the client to display the read-out corresponding part of said desired master file on the display screen of the client as the object file.

23. A recording medium in which an image delivery program for delivering an object moving-visual-image file (hereinafter called the object file) from a server to a client is recorded, wherein said program instructs a computer at the server to execute the steps of:
(a) rendering the client to display, on a display screen of the client, a message asking a user to input user identification information on the client;
(b) rendering the client to display, on the display screen of the client, (i) a title or titles of one or more master files (each hereinafter called the master file) linked with the last-named user identified by the input user identification information, each master file containing individual moving visual images of a plurality of users including said last-named user and being previously obtained by videoing the plural users substantially continuously and stored in a storage device, which is a component of the server or an external element communicably connected with the server, and (ii) a plurality of predetermined editing ways for designation and selection by said last-named user; and
(c) upon receipt of an object-file editing and delivery request, which designates the title of a particular one master file and selects a desired one of the plural predetermined editing ways, of said last-named user from the client, (c1) reading out a corresponding one of the plural parts of said particular one master file, in which part said last-named user appears, from the storage device based on the designated title of said particular one master file and time codes representing a location or a set of locations of said corresponding one part in which said last-named user appears, (c2) editing the read-out part of said particular one master file in the selected predetermined editing way, and (c3) rendering the client to display the resulting part of said particular one master file object on the display screen of the client as the edited object file.

24. A recording medium according to claim 23, wherein said program instructs the computer at the server to execute the following added steps of:
(d) rendering the client to display, on the display screen of the client, a message asking the user if the edited object file is approved by the user; and
(e) upon receipt of the approval of the edited object file from the client, downloading the requested edited object file to the client.
